(19) United States
(12) Patent Application Publication
(10) Pub. No.: US 2024/0262951 A1
(43) Pub. Date: Aug. 8, 2024

(54) FLAME RETARDANT RIGID HIGH DENSITY POLYURETHANE FOAM

(71) Applicants: Dow Global Technologies LLC, Midland, MI (US); Dow Quimica Mexicana S.A.de C.V., Ciudad De Mexico (MX)

(72) Inventors: Alvaro Ballesteros Cardenas, Puebla (MX); Omar Hernandez Muñoz, Puebla (MX); Dakai Ren, Manvel, TX (US); Adebola O. Ogunniyi, Lake Jackson, TX (US)

(21) Appl. No.: 18/687,591

(22) PCT Filed: Oct. 24, 2022
(86) PCT No.: PCT/US2022/047530

§ 371 Date: Feb. 28, 2024

Related U.S. Application Data
(60) Provisional application No. 63/271,418, filed on Oct. 25, 2021.

(51) Int. Cl. C08G 18/42; C08G 18/08; C08G 101/00; C08J 9/14; C08K 5/521

(52) U.S. Cl. CPC C08G 18/4213; C08G 18/14; C08J 9/144; C08K 5/521; C08G 2101/00; C08G 2110/0025; C08G 2110/0066; C08G 2110/0083; C08J 2203/10; C08J 2203/142; C08J 2203/162; C08J 2205/10; C08J 2375/06; C08K 2201/019

(57) ABSTRACT

The present invention provides all liquid, two-component foam forming compositions for forming fire-resistant rigid polyurethane foams comprising a chlorine-free liquid flame retardant (FR) additive. The compositions comprise a polyisocyanate component and, as a separate component, a polyol component of a blend of one or more high hydroxyl functional aromatic polyester polyols and one or more low hydroxyl functional aromatic polyester polyols, a novolac polyether polyol, a trimerization catalysts, a liquid FR additive, preferably, one FR additive, more preferably, a halogen free FR additive, and water, or water and a physical blowing agent as a blowing agent. The low hydroxyl functional aromatic polyester polyols enable the provision of readily processible, all liquid polyol components having a low viscosity as well as ASTM E84A Class A rated rigid polyurethane foams.

### FIELD

The present invention relates to flame retardant rigid polyurethane foams, such as, high density polyurethane foams, comprising a chlorine-free flame retardant (FR) additive. More particularly, the present invention relates to fire-rated, high density 160 to 480 kg/m³ (10 to 30 pounds per cubic foot) rigid polyurethane foams comprising, in condensed form, an aromatic polyisocyanate, and a polyester polyol blend of a high hydroxyl functional polyester polyol and a low hydroxyl functional polyester polyol with a novolac polyether polyol and a chlorine-free FR additive, or, preferably, a halogen-free phosphate FR additive, and to rigid polyurethane foams useful in insulation and as a light-weight synthetic replacement for building materials such as wood and stone.

### INTRODUCTION

Driven by increasing fire retardance requirements, imitation wood and stone articles used in various construction markets today must meet stringent fire ratings, such as a Class A fire rating as determined in accordance with ASTM E-84, having a Flame Spread Index (FSI) of <25, and a Smoke Developed Index (SDI) of <450. This presents a significant technical challenge to those providing high density foam products because of their large fuel load. A high smoke development from a large fuel load has historically been a key failure mechanism in rigid polyurethane foams. Smoke and toxic gases generated during fires have proven detrimental to human health and can prevent people from orienting themselves and finding the exits of a building or structure during a fire. Accordingly, in addition to improving the flame resistant behavior of construction materials, it is desirable to reduce and minimize the amount of smoke released during a fire.

Prior attempts to provide fire-retardant, high-density polyurethane foams have comprised the use of flame retardant (FR) additives, particularly solid FR additives. However, including significant amounts of solid particles or solid additives can impose major processing difficulties, for example, leading to phase separation of the solid additive from the other materials in a polyol component and causing abrasion and wear in high-pressure machines that are conventionally used to process polyurethane foam forming compositions. Thus, users of foam forming materials comprising solid materials have to purchase special equipment capable of processing compositions containing solid materials. Accordingly, toxic liquid halogen containing FR additives, such as halogen containing phosphates have been preferred as FR additives. One such halogen containing phosphate FR additive, tris (2-chloro-isopropyl) phosphate (TCPP), effectively reduces flame spread and smoke generation in high-density polyurethane foams. However, TCPP is a non-reactive flame retardant that is not incorporated into or tethered to the polymer chains in the foam matrix and thus can leach out into the environment. Given concerns about the potential health and environmental impacts of such materials, it would therefore be desirable to provide Class A fire rated high-density polyurethane foams without adding non-reactive, chlorine containing flame retardant additives, like TCPP.

Further, to achieve necessary mold filling to make a high-density polyurethane foam article, the mold is generally overpacked, which means the amount of foam forming reaction mixture exceeds the minimum amount needed to fill the mold cavity, and may be at least 50% more than the minimum amount needed to fill the mold cavity. As a result, the expansion from the blowing gases during the molding process can develop high internal pressure that causes swelling and/or cracking defects in the articles after demolding. It would thus be desirable to provide a composition that enables a pour in place method to make a high-density polyurethane foam.

US2006/0100295 A1, to Heraldo et al., discloses an all-liquid polyurethane foam forming composition in two-parts that provides rigid, high density polyurethane foams that meet the ASTM E84 Class I (Class A) requirements. The polyol second part comprises a polyester polyol and at least two liquid halogen containing flame retardants including a non-reactive halogen containing organic phosphate. While the disclosed foam forming composition has an isocyanate index ranging of 95 to 130, the disclosure at [0083] indicates that foam forming compositions having an isocyanate index above 120 would be expected to provide foams having increased brittleness. All foams disclosed as meeting the Class A requirements contained at least 7 parts of TCPP per hundred parts weight of the two-component foam forming composition.

The present inventors have endeavored to provide a flame retardant rigid polyurethane foam that is free of chlorine containing flame retardant additives, or, preferably, any non-reactive halogen containing flame retardant additives, and that meets or exceeds the Class A fire rating requirement as determined in accordance with ASTM E-84 while maintaining acceptable physical and mechanical properties and a low viscosity readily processible, fully liquid, composition for making such a rigid foam.

### SUMMARY

In accordance with the present invention, a two-component, all-liquid foam forming composition for making a fire-resistant rigid polyurethane foam comprises:
a polyisocyanate component of:
   (a) one or more aromatic polyisocyanates having on average from 2 to 5 isocyanate groups, or, preferably, on average, from 2.5 to 5 isocyanate groups, preferably, methylene di (phenyl isocyanate) (MDI), an MDI isomer, an oligomer of MDI, a prepolymer of MDI, or a mixture of two or more thereof, more preferably, an oligomer or prepolymer of MDI wherein the oligomer of MDI or the prepolymer of MDI has, on average, from 2.5 to 5 isocyanate groups; and,
as a separate component,
   a polyol component of:
   (b)(i) from 47 to 86.75 wt. %, or, preferably, from 67.4 to 82.5 wt. %, based on the total weight of the polyol component, of a blend of from 20 to 80, or, preferably, from 30 to 70 weight parts of the total weight of (b)(i) of (A) one or more high hydroxyl functional aromatic polyester polyols having a hydroxyl functionality of from 2.5 to 4, or, preferably, from 2.6 to 3 and, having a hydroxyl number as determined in accordance with ASTM D4274 of from 200 to 350 mg KOH/g, and from 20 to 80, or, preferably, from 30 to 70 weight parts of the total weight of (b)(i) of (B) one or more low hydroxyl functional aromatic polyester polyols having a hydroxyl functionality of from 1.8 to less than 2.5, having a viscosity at 25° C., as determined in accordance with ASTM D4878 using a viscometer equipped with a rotating spindle of from 1000 to less than 7000 cPs or, preferably, from 1000 to 5000 cPs, and having an hydroxyl number of from 180 to 350 mg KOH/g, wherein the difference in the average hydroxyl functionality of the (b)(i)(A) one or more hydroxyl functional aromatic polyester polyols and the (b)(i)(B) one or more low hydroxyl functional aromatic polyester polyols is 0.2 or more hydroxy groups or, preferably, 0.25 or more hydroxyl groups;
   (b)(ii) from 8 to 20 wt. %, or, preferably, from 10 to 18 wt. %, based on the total weight of the polyol component, of one or more novolac polyether polyols having a hydroxyl functionality as determined in accordance with of from 2 to 6, or, for example, from 3 to 6 and a hydroxyl number of from 150 to 320;
   (c) from 0.2 to 2.0 wt. %, such as from 0.2 to 0.8 wt. %, or, preferably, from 0.4 to 0.6 wt. %, based on the total weight of the polyol component, of one or more trimerization catalysts, such as an amine containing trimerization catalyst, an alkali metal salt trimerization catalyst, or, preferably, a mixture of an amine containing trimerization catalyst and an alkali metal salt, such as a potassium carboxylate, for example, potassium acetate;
   (d) from 2 to 6 wt. %, or, preferably, from 2 to 4 wt. %, based on the total weight of the polyol component, of a surfactant, such as a nonionic surfactant, or a silicon containing surfactant;
   (e) from 0.05 to 10 wt. %, or, from 0.1 to 10 wt. %, based on the total weight of the polyol component, of water or a liquid physical blowing agent, or a blowing catalyst or a mixture of two or more thereof as a blowing agent, wherein water comprises no more than 2 wt. %, based on the total weight of the polyol component, such as, a mixture of water and a liquid physical blowing agent, preferably, water; and,
   (f) from 3 to less than 15 wt. % or, preferably, from 5 to 10 wt. %, based on the total weight of the polyol component, of a liquid chlorine-free flame retardant additive, such as, for example, a liquid phosphate or mixture of a liquid phosphate and a reactive bromine containing flame retardant additive, such as a liquid bromine containing flame retardant additive having a hydroxyl functionality greater than 1, or, preferably, a trialkyl phosphate, a triaryl phosphate, a phosphate ester and a resorcinol bis(diphenyl phosphate), or, more preferably, a trialkyl phosphate having three alkyl groups with at least one alkyl group having from 2 to 12 carbon atoms and the other two alkyl groups, independently, containing from one to 8 carbon atoms, or a mixture thereof with a reactive bromine containing flame retardant additive, wherein the two-component foam forming composition has an isocyanate index ranging from 120 to 240 or, preferably, from 150 to 200 and all wt. % s add up to 100%. The polyol component of the foam forming compositions of the present invention may have a viscosity at 25° C., as determined in accordance with ASTM D4878 using a viscometer equipped with a rotating spindle of from 1000 to 3,500 cPs, or, preferably, less than 3,000 cPs, or, more preferably, 2000 cPs or less. More preferably, the foam forming compositions of the present invention comprise (f) one or more halogen-free liquid FR additives and comprise no metal smoke suppressant. Preferably, the foam forming compositions consist essentially of just (f) one halogen-free liquid phosphate flame retardant additive.

The polyol component of the two-component composition of the present invention may further comprise:
(g) of one or more gelling catalysts, such as an aromatic amine tertiary amine catalyst, for example, benzyl dimethylamine. The total amount of the (g) gelling catalyst may range from 0.2 to 1.0 wt. %, based on the total weight of the polyol component.

Still further, the polyol component of the two-component foam forming compositions of the present invention may comprise:
(h) one or more additives chosen from a (i) reactive diluent, such as a diol or triol, or (ii) a crosslinker, such as a trifunctional crosslinker, for example, tri(isopropanol) amine or triethanolamine, or (iii) a diluent solvent, such as propylene carbonate, a mixture of (i) and (ii), a mixture of (ii) and (iii), or a mixture of (i), (ii) and (iii). Total amounts of the (h)(i) diluent may range from 0 to 10 wt. %, based on the total weight of the polyol component. Total amounts of the (h)(ii) crosslinker may range from 0 to 8 wt. %, based on the total weight of the polyol component. Total amounts of the (h)(iii) diluent solvent may range from 0 to 10 wt. %, based on the total weight of the polyol component.

In accordance with another aspect of the present invention, a flame retardant rigid polyurethane foam comprises the reaction product of the two-component foam forming compositions of the present invention and has a density as determined in accordance with ASTM D 1622 of from 160 to 480 kg/m³, or, preferably, from 160 to 450 kg/m³, or more preferably, from 200 to 400 kg/m³.

In another aspect, a rigid polyurethane foam in accordance with the present invention may comprise:
(a) in condensed form, one or more aromatic polyisocyanates having from 2 to 5 isocyanate groups, or, preferably, on average, from 2.5 to 5 isocyanate groups and containing at least one isocyanurate ring, preferably, an isocyanurate of methylene di(phenyl isocyanate) (MDI), an MDI isomer, an oligomer of MDI containing at least one isocyanurate ring, a prepolymer of MDI containing at least one isocyanurate ring, or a mixture of two or more thereof, or, more preferably, an oligomer or prepolymer of MDI wherein the oligomer of MDI or the prepolymer of MDI has, on average, from 2.5 to 5 isocyanate groups; and
(b)(i) in condensed form, from 57 to 86.8 wt. %, or, preferably, from 67.2 to 84.8 wt. %, based on the total weight of the polyurethane foam except for the weight, in condensed form, of the (a) one or more aromatic polyisocyanates, of a blend of from 30 to 70 weight parts of the total weight, in condensed form, of (b)(i) of (A) one or more high hydroxyl functional aromatic polyester polyols having a hydroxyl functionality of from 2.5 to 4, or, preferably, from 2.6 to 3, and having a hydroxyl number as determined in accordance with ASTM D4274 of from 200 to 350 mg KOH/g, and from 30 to 70 weight parts of the total weight, in condensed form, of (b)(i) of (B) one or more low hydroxyl functional aromatic polyester polyols having a hydroxyl functionality of from 2 to less than 2.5, and having a hydroxyl number as determined in accordance with ASTM D4274 of from 180 to 350 mg KOH/g, wherein the difference in the average hydroxyl functionality of the (b)(i)(A) one or more hydroxyl functional aromatic polyester polyols and the (b)(i)(B) one or more low hydroxyl functional aromatic polyester polyols is 0.2 or more hydroxy groups or, preferably, 0.25 or more hydroxyl groups and;
(b)(ii) from 8 to 20 wt. %, or, preferably, from 10 to 18 wt. %, based on the total weight of the polyurethane foam except for the weight, in condensed form, of the (a) one or more aromatic polyisocyanates, of one or more novolac polyether polyols having a hydroxyl functionality of from 2 to 6, or, for example, from 3 to 6 and a hydroxyl number as determined in accordance with ASTM D4274 of from 150 to 320;
(c) dispersed within the polyurethane foam from 0.2 to 2 wt. %, or, preferably, from 0.2 to 0.8 wt. %, based on the total weight of the polyurethane foam except for the weight, in condensed form, of the (a) one or more aromatic polyisocyanates, of one or more trimerization catalysts, such as an amine containing trimerization catalyst, an alkali metal salt trimerization catalyst, or, preferably, a mixture of an amine containing trimerization catalyst and an alkali metal salt, such as a potassium carboxylate, for example, potassium acetate;
(d) dispersed within the polyurethane foam from 2 to 6 wt. % or, preferably, from 2 to 4 wt. %, based on the total weight of the polyurethane foam except for the weight, in condensed form, of the (a) one or more aromatic polyisocyanates, of a nonionic surfactant, such as a silicon containing surfactant; and,
(f) dispersed within the polyurethane foam from 3 to less than 15 wt. % or, preferably, from 5 to 10 wt. %, based on the total weight of the polyurethane foam except for the weight, in condensed form, of the (a) one or more aromatic polyisocyanates, of a chlorine-free liquid flame retardant additive, such as liquid phosphate or mixture of a liquid phosphate and a reactive bromine containing flame retardant additive, such as one containing at least one hydroxyl group, or, more preferably, a trialkyl phosphate having three alkyl groups with at least one alkyl group having from 2 to 12 carbon atoms and the other two alkyl groups, independently, containing from one to 8 carbon atoms,
wherein the rigid polyurethane foam comprises at least one isocyanurate group, and all wt. % s add up to 100%, and,
further wherein, the rigid polyurethane foam of the present invention has a density as determined in accordance with ASTM D 1622 of from 160 to 480 kg/m³ (10 to 30 pounds per cubic foot) or, preferably, from 160 to 450 kg/m³, or, more preferably, from 200 to 400 kg/m³. The (b)(i)(A) one or more high hydroxyl functional aromatic polyester polyols has a viscosity at 25° C., as determined in accordance with ASTM D4878 using a viscometer equipped with a rotating spindle of from from 5000 to 25000 cPs, or, preferably, from 6000 to 20,000 cPs. Preferably, the rigid polyurethane foam is free of solid additives, such as melamine flame retardants, or is free of halogen containing flame retardant additives, or, more preferably, the rigid polyurethane foam is free of solid additives and is free of halogen containing flame retardant additives.

The rigid polyurethane foams of the present invention meet the requirements of the ASTM E84 Class I (Class A) as a foam having a 2.54 cm (1 in) thickness and exhibits a smoke developed index (SDI) of 450 or less or, preferably, 250 or less, and a flame spread index (FSI) of 25 or less.

### DETAILED DESCRIPTION

In accordance with the present invention, rigid, high-density polyurethane (PU) foams made with no solid additives, and no chlorine containing flame retardant (FR) additives, such as chlorinated phosphates, like trichloropolyphosphate (TCPP), provide flame retardant properties that meet and exceed the requirements of testing in accordance with ASTM E84 Class I (Class A) when tested as a board having a 2.54 cm (1 inch) thickness. For example, the rigid polyurethane foams have a significantly improved smoke suppression performance when burned. The present inventors have found that a foam forming composition comprising a combination of an aromatic polyisocyanate and a polyol component of an aromatic polyester polyol having 2.5 or more hydroxyl functional groups, an aromatic polyester polyol having less than 2.5 hydroxyl functional groups, a novolac polyether polyol, a halogen-free phosphate flame retardant and a trimerization catalyst enables the making of the rigid polyurethane foams with enhanced flame retardant properties. The foam forming compositions are all liquid and have a viscosity that enables optimum processing without requiring specialized equipment needed to process solids in foam formation. The rigid foams and foam forming compositions for making them comprise no solid phase additives or reactants, and may be free, for example, of inorganic fillers, like metal-containing inorganic fillers or expanded graphite. The rigid foams and foam forming compositions for making them are free of solid FR additives, or chlorine containing FR additives or, preferably, comprise no halogen containing FR additives and no solid FR additives. Further, the rigid foams and foam forming compositions preferably only comprise one FR additive, such as a liquid FR additive. In addition, the foams and foam forming compositions have a significantly lower flame retardant content than known and comparable rigid foams that exhibit the same flame retardant properties. Further, the foams and the foam forming compositions for making them have no metal containing smoke suppressant. Still further, the rigid polyurethane foams of the present invention may be prepared by pour-in-place molding. The polyol component of the foam forming composition enables production of foams with reduced foam article defects, and improved mechanical performance, such as reduced brittleness at an isocyanate index above 120. The rigid polyurethane foams molded from the compositions of the present invention retain physical-mechanical properties acceptable for wood and stone building material replacements and insulation.

All ranges recited are inclusive and combinable. For example, a disclosed range of a hydroxyl functionality of from 2.5 to 4, or, preferably, from 2.6 to 3 includes all of a hydroxyl functionality of from 2.5 to 4, or, from 3 to 4, or, from 2.5 to 2.6, or, preferably, from 2.6 to 3, or, from 2.5 to 3.

Unless otherwise indicated, conditions of temperature and pressure are ambient temperature (21-25° C.), a relative humidity of 50%, and standard pressure (1 atm).

Unless otherwise indicated, any term containing parentheses refers, alternatively, to the whole term as if parentheses were present and the term without them, as well as combinations of each alternative. Thus, for example, as used herein the term, “blowing agent(s)” is intended to include a blowing agent, or mixtures thereof.

As used herein, the term “ASTM” refers to publications of ASTM International, Conshohocken, Pa.

As used herein, the term “component” refers to a composition containing one or more ingredients which is combined with another component to start a reaction, polymerization, foam formation or cure. Components are kept separate until combined at the time of use or reaction

As used herein, the term “DIN” refers to publications of the Deutsches Institut fur Normung, the German Institute for Standardization, Berlin, Germany.

As used herein, the term “in condensed form” means the form of a material after the foaming reaction and polyurethane formation are complete, and is not limited to the product of a condensation or addition reaction.

As used herein, the term “ISO” refers to the publications of the International Organization for Standardization, Geneva, CH.

As used herein, the term “exotherm” refers to heat generated by a reaction that results in a rising or at least a steady elevated temperature (above room temperature) without the addition of any heat.

As used herein, the term “hydroxyl number” in mg KOH/g of analyte refers to the amount of KOH needed to neutralize the acetic acid taken up on acetoylation of one gram of the analyte material as determined in accordance with ASTM D4274.

As used herein, the term “hydroxyl equivalent weight” or “equivalent weight” or “EW” of a given polyether polyol or polyol refers to calculated value as determined by the equation:

EW=56,100/hydroxyl number of a given polyol.

As used herein, the term “hydroxyl functionality” refers to the number of hydroxyl groups in a given polyol. Average hydroxyl functionality is determined herein by dividing the number average molecular weight (Mₙ) by its hydroxy equivalent weight. As used herein, the “number average molecular weight” or Mₙ may be measured by well-known methods, for example, gel permeation chromatography (GPC) in conjunction with standards such as polyethylene glycol, of known molecular weights. As used herein, the term “average hydroxyl functionality” in a blend of two or more polyols refers to the weighted average of the hydroxyl functionality of the polyols in the blend. Thus, for example, in a 50:50 (w/w solids) blend of a given polyol having a hydroxyl functionality of 3 and a given polyol having a hydroxyl functionality of 2, the average hydroxyl functionality is (3-0.5+2-0.5) or (1.5+1) or 2.5.

As used herein, unless otherwise indicated, the term “isocyanate index” or simply “index” refers to the ratio of the number of equivalents of isocyanate functional groups to the number of equivalents of hydroxyl groups in a given polyurethane (foam) forming reaction mixture, multiplied by 100 and expressed as a number. For example, in a reaction mixture wherein the number of equivalents of isocyanate equals the number of equivalents of active hydrogen, the isocyanate index is 100. For the purpose of calculating the number of isocyanate groups, an isocyanurate is considered as having three (3) isocyanate groups per ring.

As used herein, the term “isocyanate reactive group” refers to a hydroxyl group or an amine group. As used herein, the term “polyisocyanate” refers to an isocyanate group containing material having two or more isocyanate functional groups, such as a diisocyanate, or a dimer or trimer thereof, or an oligomer thereof made by reaction of an excess of isocyanate with one or more diols.

As used herein, the term “solid material” or “solid additive” refers to solid phase material or a crystalline or amorphous substance that does not flow perceptibly under moderate stress, has a definite capacity for resisting forces which tend to deform it, and under standard conditions retains a definite size and shape.

As used herein, the term “total solids” or “solids” refers to everything in a given composition other than water, ammonia and any volatile solvents or materials which flash off or volatilize at below 60° C. and atmospheric pressure, regardless of phase. As the foam forming compositions react to form polyurethane foams, all polyols, diols and polyisocyanates become solid materials even if they comprise a liquid phase material before they react.

As used herein, the phrase “wt. %” stands for weight percent.

The rigid polyurethane foams in accordance with the present invention may be made from foam forming compositions of a two-component reaction mixture of a polyisocyanate component, and a polyol component. Each of the two components of the foam forming compositions react to form a polyurethane or polycarbamate, or polyisocyanurate by a conventional reaction of a hydroxyl group with an isocyanate group or an isocyanurate ring. As the reaction to form a polyurethane conforms to stoichiometric ratios of hydroxyl groups to isocyanate groups or one-third of isocyanurate rings, the relative ratios of any hydroxyl and any amine groups in the polyol component and isocyanate groups in the polyisocyanate component in the foam forming compositions of the present invention are the same as the relative ratios of the hydroxyl groups and isocyanate groups, in condensed form, in the rigid polyurethane foams of the present invention. For the purposes of the present invention, in the rigid polyurethane foams of the polyurethane foams, all other materials in the foam forming compositions, including the (c) one or more trimerization catalysts, the (d) surfactants, (f) flame retardant additives, (g) gelling catalysts, such as tertiary amines or amine catalysts; (h)(1) diluents and (h)(2) crosslinkers are treated as if they remain in the rigid polyurethane foams in the same relative proportions as in the foam forming compositions from which the foams are made. However, some or all of a given catalyst and other non-reactive material may volatilize during foam formation.

The foam forming compositions and the rigid polyurethane foams of the present invention contain no solid additive and are all liquid. Further, the foam forming compositions may contain no diluent, or crosslinking agent. The foam forming compositions comprise little or no added organic solvent or volatile liquids other than those needed to act as a carrier, such as for a (g) gelling catalyst. Thus, the foam forming compositions of the present invention comprise 2 wt. % or less of organic solvents or volatile liquids, based on the total weight of the foam forming compositions. For the purposes of the present invention, any (h)(iii) a diluent solvent and any (e) liquid physical blowing agent is not considered as an organic solvent or volatile liquid.

The polyol component and the polyisocyanate component comprise polyols and polyisocyanates in neat form. For example, the (b)(i) hydroxyl functional aromatic polyester polyols may act as a carrier and the (g) gelling catalysts may comprise roughly half of a diol or extender as carrier.

In the rigid polyurethane foams of the present invention, excess (a) polyisocyanate groups are present in the forming of the polyurethane. The foam forming compositions in accordance with the present invention thus may have an isocyanate index ranging from 120 to 240 or, preferably, from 150 to 200.

The polyisocyanate component of the two-component foam forming composition of the present invention comprises (a) one or more aromatic polyisocyanates, such as an aromatic diisocyanate having from 2 to 5 isocyanate groups, or, preferably, on average, from 2.5 to 5 isocyanate groups.

Such polyisocyanates can be diisocyanates, buirets, allophanates, ureas, dimers, trimers, carbodiimides and/or uretonomines, and prepolymers containing one or more urethane groups made, for example, from an excess of a polyisocyanate and one or more diols, (poly)ether diols or polyols having three or more hydroxyl groups, such as glycerol under conditions that do not lead to gelation or solidification. Isocyanate functionality comprises the weighted average of all molecules in a polyisocyanate composition that comprises more than one polyisocyanate or a mixture or distribution of polyisocyanates. For example, a 50:50 mole/mole mixture of a diisocyanate and a dimer thereof having three isocyanate functional groups would be considered as having 2.5 isocyanate groups. For prepolymers, the number of isocyanate groups equals the weighted average of the number of hydroxyl groups in the diol or polyol used to make the prepolymer and the number of isocyanate groups in the remaining unreacted isocyanates used to make the prepolymer.

Each of the (a) one or more aromatic polyisocyanates may have a number average molecular weight of 150 g/mol to 750 g/mol. The aromatic polyisocyanates can be monomeric and/or polymeric. For example, suitable aromatic polyisocyanates can have a number average molecular weight from a low value of 150, 200, 250 or 300 g/mol to an upper value of 350, 400, 450, 500 or 750 g/mol. Polyisocyanate prepolymers can have a number average molecular weight of up to 750 g/mol, as can be calculated from the number average molecular weight (Mₙ) of each reactant and their relative masses used in preparing the prepolymer. The number average molecular weight values reported herein are determined by end group analysis, gel permeation chromatography, and other methods, as is known in the art. In addition, an aromatic polyisocyanate can have an isocyanate equivalent weight of 80 to 400, for example, of from 80 to 150, or, from 100 to 145, or, from 110 to 140.

Suitable aromatic polyisocyanates for use in the foam forming compositions may include, for example, 4,4′-, 2,4′ and 2,2′-isomers of diphenylmethane diisocyanate (MDI) and their isomeric mixtures, 2,6 isomers of toluene diisocyanate or 2,4 isomers of toluene diisocyanate (TDI) and their isomeric mixtures, m- and p-phenylenediisocyanate, diphenylene-4,4′-diisocyanate, 4,4′-diisocyanate-3,3′-dimethyldiphenyl, 3-methyldiphenyl-methane-4,4′-diisocyanate and diphenylether diisocyanate and 2,4,6-triisocyanatotoluene and 2,4,4′-triisocyanatodiphenylether, tris-(4-isocyanatophenyl)methane, toluene-2,4,6-triyl triisocyanate; alkylaryl polyisocyanates such as xylene diisocyanate; 4,4′-dimethyldiphenylmethane-2,2′,5′,5′-tetra(isocyanate), a crude polyisocyanate such as crude toluene diisocyanate and crude methylene diphenyl diisocyanate or mixtures thereof, naphthylene-1,5-diisocyanate, 1-methoxyphenyl-2,4-diisocyanate, diphenylmethane-4,4′-biphenylene diisocyanate, 3,3′-dimethoxy-4,4′-biphenyl diisocyanate, 3,3′-dimethyl-4,4′-biphenyl diisocyanate, 3,3′-dimethyldiphenylmethane-4,4′-diisocyanate, isophorone diisocyanate, 1,3-bis-(isocyanatomethyl)benzene, cumene-2,4-diisocyanate, 4-methoxy-1,3-phenylene diisocyanate, 4-ethoxy-1,3-phenylene diisocyanate, 2,4′-diisocyanatodiphenyl ether, 5,6-dimethyl-1,3-phenylene diisocyanate, 2,4-dimethyl-1,3-phenylene diisocyanate, 4,4-diisocyanatodiphenyl ether, benzidine diisocyanate, 4,6-dimethyl-1,3-phenylene diisocyanate, 9,10-anthracene diisocyanate, 4,4′-diisocyanatodibenzyl, 3,3′-dimethyl-4,4′-diisocyanatodiphenylmethane, 2,6′-dimethyl-4,4′-diisocyanatodiphenyl and mixtures of any two or more thereof.

Preferably, the (a) aromatic polyisocyanate comprises methylene di (phenyl isocyanate) (MDI), an MDI isomer, an oligomer of MDI, a prepolymer of MDI, or a mixture of two or more thereof. Preferred MDI isocyanates include, for example, a blend of MDI and a polymeric MDI, such as a dimer or trimer of MDI, or a polyisocyanate functional urethane prepolymer, such as the reaction product of an excess of MDI with a diol, one or more of various MDI isomers, such as diphenylmethane-4,4′-diisocyanate or diphenylmethane-2,4′-diisocyanate; hydrogenated MDI, such as hydrogenated diphenylmethane-4, 4′-diisocyanate or hydrogenated diphenylmethane-2,4′-diisocyanate; methoxyphenyl-2,4-diisocyanate, 4,4′-biphenylene diisocyanate, 3,3′-dimethoxy-4,4′-biphenyl diisocyanate, 3,3′-dimethyl-4-4′-biphenyl diisocyanate, or 3,3′-dimethyldiphenyl methane-4,4′-diisocyanate. Diphenylmethane-4, 4′-diisocyanate, diphenylmethane-2,4′-diisocyanate and mixtures thereof are generically herein referred to as “MDI”. Polymeric MDI as used herein, refers to polymethylene poly (phenyl isocyanate) which unlike monomeric diisocyanate (i.e., two-ring molecules) contains three-ring and higher ring-containing products. The polyol component of the foam forming compositions of the present invention have a low viscosity at 25° C. as determined in accordance with ASTM D4878 of less than 3,500 cPs, or, preferably, of less than 3,000 cPs, or, more preferably, of less than 2000 cPs. Such a low viscosity stems from the polyol composition, wherein at least a portion of the polyols has a higher hydroxyl number and, thus a lower molecular weight. The (b)(i)(B) lower hydroxyl functional aromatic polyester polyols have less branching and thus also contribute to the lower viscosity. In addition, the lack of solid additives, such as melamine FR additives, contributes to a lower viscosity.

The polyol component of the two-component foam forming compositions of the present invention comprises (b)(i)(A) one or more high hydroxyl functional aromatic polyester polyols having a hydroxyl functionality of from 2.5 to 4, or, preferably, from 2.6 to 3 and, having a hydroxyl number as determined in accordance with ASTM D4274 of from 200 to 350 mg KOH/g, The polyol component of the two-component foam forming compositions of the present invention also comprise (b)(i)(B) one or more low hydroxyl functional aromatic polyester polyols having a hydroxyl functionality of from 1.8 to less than 2.5, and having a hydroxyl number as determined in accordance with ASTM D4274 of from 180 to 350 mg KOH/g. The (b)(i)(A) high hydroxyl functional aromatic polyester polyols and the (b)(i)(B) low hydroxyl functional aromatic polyester polyols comprise a blend, such as a 20 to 80:80 to 20 (w/w) blend. The difference in the average hydroxyl functionality of the (b)(i)(A) one or more hydroxyl functional aromatic polyester polyols and the (b)(i)(B) low hydroxyl functional aromatic polyester polyols is 0.2 or more hydroxy groups or, preferably, 0.25 or more hydroxyl groups, or, even more preferably, 0.3 or more hydroxyl groups.

The (b)(i) hydroxyl functional aromatic polyester polyols of the present invention may be formed in a conventional manner by forming an aromatic polyester and reacting it with a polyether polyol. The aromatic polyester may be formed, for example, by reacting a diol or or polyhydric alcohol (polyol) in the presence of an aromatic polycarboxylic acid or an aromatic anhydride and, optionally, an acidic or basic catalyst, to form an ester, followed by reacting the resulting ester with and an excess of polyether polyol or by adducting it with an alkylene oxide or a polyether polyol. For example, suitable polyester polyols include reaction products of a polyether polyol with an aromatic polyester made, for example, from any of polyhydric alcohols, such as dihydric alcohols and/or trihydric alcohols, and polybasic aromatic, such as dibasic and/or tribasic, carboxylic acids or anhydrides, or mixtures thereof. Suitable polycarboxylic acids or anhydrides may be aliphatic, cycloaliphatic, aromatic and/or heterocyclic. Suitable exemplary aromatic polycarboxylic acids, anhydrides, and polycarboxylic acid esters of lower alcohols include, but are not limited to, phthalic acid, isophthalic acid, terephthalic acid, trimellitic acid, phthalic acid anhydride, trimellitic anhydride, tetrahydrophthalic acid anhydride, hexahydrophthalic acid anhydride, dimethyl terephthalate and terephthalic acid-bis-glycol esters, or endomethylene tetrahydrophthalic acid anhydride. Exemplary suitable polyhydric alcohols include, but are not limited to, ethylene glycol, 1,2-propylene glycol, 1,3-propylene glycol, 1,4-butane diol, diethylene glycol, thiodiethanol, N-methyl diethanolamine, dipropylene glycol, 1,3-butylene glycol, 1,2-butylene glycol, 1,5-pentane diol, 1,4-pentane diol, 1,3-pentane diol, 1,6-hexane diol, 1,8-octane diol, neopentyl glycol, cyclohexane dimethanol, 1,1,7-heptane diol, diethylene glycol, triethylene glycol, tetraethylene glycol, dipropylene glycol, dibutylene glycol, (1,4-bis-hydroxy-methylcyclohexane and other isomers), 2-methyl-1,3-propane-diol, glycerol, trimethylolpropane, hexanetriol-(1,2,6), butanetriol-(1,2,4), trimethylolethane, polyethylene glycols, dipropylene glycol, polypropylene glycols, dibutylene glycol and polybutylene glycols. The aromatic polyesters contain a proportion of carboxyl end groups. In additional examples, the aromatic polyesters suitable for making the (b)(i) hydroxyl functional aromatic polyester polyols may be reaction products formed from polybasic acid of terephthalic acids and from aliphatic polyhydric alcohols comprising diethylene glycol, polyethylene glycol, and/or glycerol, and any blends thereof. Suitable polyether polyols useful in making suitable (b)(i) hydroxyl functional aromatic polyester polyols may be prepared, for example, from polyethers formed by polymerization of one or more oxiranes or cyclic ethers, such as ethylene oxide, propylene oxide, butylene oxide, styrene oxide or epichlorohydrin, such as mixtures of ethylene oxide and propylene oxide, either on their own, in the presence of alkali hydroxides (e.g. KOH) or BF₃, or by chemical addition of these oxiranes as mixtures or sequentially, to active hydrogen containing materials having reactive hydrogen atoms, such as alcohols, or amines, such as, for example, ethylene glycol, propylene glycol-(1,3) or -(1,2), glycerol, trimethylolpropane, 4,4′-dihydroxy-diphenylpropane, aniline, ethanolamine, o-toluenediamine ethylene diamine, glycosides and saccharide containing polyethers, such as sucrose-containing polyether polyols, or polyethers which contain predominant amounts of primary OH groups (up to 100% of the OH groups present in the polyether).

The suitable aromatic polyester polyols may have an aromatic content from a low value of 8, 10, 12, or 14 wt. % and a high value of 18, 20, 30, or 40 wt. %, based on the total weight of the aromatic polyester polyol. Aromatic polyester polyols may have a number average molecular weight as low as 300, 350, 400, or 425 and as high as 525, 550, 600, or 800.

The hydroxyl functionality of the (b)(i) hydroxyl functional aromatic polyester polyols may be determined by determining its number average molecular weight, such as by GPC, and dividing the Mn by the hydroxyl equivalent weight (EW).

The (b)(ii) one or more novolac polyether polyols of the present invention may be the alkoxylation products of a phenol-formaldehyde resin initiator, which is formed by the reaction of phenol with formaldehye in the presence of an acid catalyst, such as glacial acetic acid, followed by concentrated hydrochloric acid. For example, a small amount of the acid catalyst or catalysts may be added to a miscible phenol, such as p-toluenesulfonic acid, followed by formaldehyde. The formaldehyde reacts between two phenols to form a methylene bridge, creating a dimer by electrophilic aromatic substitution between the ortho and para positions of phenol and the protonated formaldehyde, for example, bisphenol F. Another example is bisphenol A, which is the condensation product of acetone with two phenols. As concentration of dimers increases, trimers, tetramers and higher oligomers may also form. However, because the molar ratio of formaldehyde to phenol is controlled at somewhat less than 1, polymerization is not completed. Thus, the novolac may then be alkoxylated to build molecular weight to a desired level, desirably from 300 to 2000, or, from 500 to 1500.

Suitable phenols which may be used to prepare the novolac initiator include, for example: o-, m-, or p-cresols, ethylphenol, nonylphenol, p-phenylphenol, 2,2-bis(4-hydroxyphenol) propane, beta-naphthol, beta-hydroxyanthracene, p-chlorophenol, o-bromophenol, 2,6-dichloro-phenol, p-nitrophenol, 4-nitro-6-phenylphenol, 2-nitro-4-methylphenol, 3,5-dimethylphenol, p-isopropylphenol, 2-bromo-4-cyclohexylphenol, 4-t-butylphenol, 2-methyl-4-bromophenol, 2-(2-hydroxypropyl)phenol, 2-(4-hydroxyphenol)ethanol, 2-carbethoxyphenol, 4-chloro-methylphenol, and mixtures thereof. The phenols used to prepare the novolac polyether polyols maybe unsubstituted.

Suitable (b)(ii) novolac polyether polyols may be produced, for example, by reacting a condensate adduct of phenol and formaldehyde with one or more alkylene oxides including ethylene oxide, propylene oxide, and butylene oxide. Such polyols, sometimes referred to as novolac-initiated polyols, are known to those skilled in the art, and may be obtained by methods such as are disclosed in, for example, U.S. Pat. No. 2,838,473 to Partansky; U.S. Pat. No. 2,938,884 to Chern; U.S. Pat. No. 3,470,118 to Forster; U.S. Pat. No. 3,686,101 to Davis; and U.S. Pat. No. 4,046,721 to Austin. The novolac condensate starting materials may be prepared by reacting a phenol (for example, a cresol) with formaldehyde where the molar ratio of formaldehyde to phenol of less than one, in the presence of an acidic catalyst to form a polynuclear condensation product containing from 2.1 to 12, such as from 2.2 to 6, or from 2.5 to 4.5 phenol units per molecule. The novolac resin is then reacted with an alkylene oxide such as ethylene oxide, propylene oxide, butylene oxide, or isobutylene oxide to form an oxyalkylated product containing a plurality of hydroxyl groups. The (b)(ii) novolac polyether polyols may have an average of from 2 to 6 hydroxyl functional groups per molecule and an average hydroxyl number of from 150 to 320 mg KOH/g, or from 150 to 300 mg KOH/g.

The total amount of the blend of the (b)(i)(A) one or more high hydroxyl functional aromatic polyester polyols and (b)(i)(B) one or more low hydroxyl functional aromatic polyester polyols in the foam forming compositions amounts to the remainder of the polyol component after the amounts all of the other polyol materials are totalled. Thus, the blend of the hydroxyl functional aromatic polyester polyols may be thought of as a carrier. Likewise, the total amount, in condensed form, of the blend of the (b)(i)(A) one or more high hydroxyl functional aromatic polyester polyols and (b)(i)(B) one or more low hydroxyl functional aromatic polyester polyols in the rigid polyurethane foams amounts to the remainder of the polyurethane after the amounts all of the other polyol component materials and of the polyisocyanate component are totalled.

The (b)(ii) novolac polyether polyols may contribute to higher viscosity in a polyol component. Accordingly, the amount of the (b)(ii) one or more novolac polyether polyols in the polyol component of the foam forming compositions ranges 20 wt. % or less or, preferably, 18 wt. % or less, based on the total weight of the polyol component. Likewise, in the rigid polyurethane foams, the total amount of the (b)(ii) one or more novolac polyether polyols, present in condensed form, comprise the same relative amount as they do in the foam forming compositions. Accordingly, the amount of the (b)(ii) one or more novolac polyether polyols, in condensed form, ranges 20 wt. % or less or, preferably, 18 wt. % or less, based on the total weight of the polyurethane foam except for the weight, in condensed form, of the (a) one or more aromatic polyisocyanates.

The polyol component of the foam forming compositions of the present invention further comprises (c) one or more trimerization catalysts.

The (c) one or more trimerization catalysts suitable for use in the foam forming compositions of the present invention may include any known to those skilled in the art, including glycine salts, tertiary amine trimerization catalysts, alkali metal alkoxides, alkali metal salts, such as alkali metal carboxylates, and mixtures thereof. Examples of the trimerization catalysts include, for example, quaternary ammonium salts, 2,4,6-(N,N-dimethylaminomethyl)phenols, hexahydrotriazines, potassium salts of carboxylic acids such as potassium octoate, potassium acetate, and mixtures thereof. Representative of commercially available trimerization catalysts may include, for example, any of DABCO™ TMR, DABCO™ TMR-2, DABCO™ TMR-3, DABCO™ TMR-4, DABCO™ TMR-18, DABCO™ K15 or, for example, DABCO™ K2097 catalysts from Evonik industries, Essen, DE.

Suitable total amounts of the (c) one or more trimerization catalysts in the foam forming compositions of the present invention may range from 0.2 to 2 wt. %, or, from 0.2 to 0.8 wt. %, based on the total weight of the polyol component. Likewise, in the rigid polyurethane foams, the total amount of the (c) one or more trimerization catalysts, present in condensed form, may comprise the same relative amount as they do in the foam forming compositions after volatiles are removed. The (c) one or more trimerization catalysts may be volatile and may be removed upon foam formation. Accordingly, the amount of the (c) one or more trimerization catalysts may range from 0 to 2 wt. %, or from 0.2 to 0.8 wt. %, based on the total weight of the polyurethane foam except for the weight, in condensed form, of the (a) one or more aromatic polyisocyanates.

The rigid polyurethane foams of the present invention comprise (d) surfactants or emulsifiers, such as nonionic surfactants, and (g) gelling catalysts, such as tertiary amines. The rigid polyurethane foams may further comprise (h)(i) reactive diluents; (h)(ii) crosslinking agents; (h)(iii) diluent solvents; preservatives, colorants, or antioxidants. In the foams, any (h)(i) diluents and (h)(ii) crosslinking agents will be in condensed form. Likewise, the polyol component of the polyurethane foam forming compositions comprises (d) surfactants or emulsifiers, such as nonionic surfactants, and (g) gelling catalysts, such as tertiary amines. The polyol component may optionally contain auxiliary additives, including, for example, (h)(i) diluents; (h)(ii) crosslinking agents; (h)(iii) diluent solvents; preservatives, colorants, or antioxidants.

Examples of suitable (d) surfactants include one or more silicon surfactants, including commercially available polysiloxane/polyether copolymers; nonionic surfactants, such as nonionic polyether surfactants, such as polyoxyethylene-polyoxybutylene block copolymers; and long chain alcohol or aromatic group containing surfactants. Some representative materials are, generally, polysiloxane polyoxylalkylene block copolymers, such as those disclosed in U.S. Pat. No. 2,834,748 to Bailey; U.S. Pat. No. 2,917,480 to Bailey; and U.S. Pat. No. 2,846,458 to Haluska. Also included are organic surfactants, as disclosed in U.S. Pat. No. 5,600,019 to Bhattacharjee. Other surfactants may include polyethylene glycol ethers of long-chain alcohols, tertiary amine or alkanolamine salts of long-chain allyl acid sulfate esters, alkylsulfonic esters, alkyl arylsulfonic acids, and combinations thereof.

The (d) one or more surfactants may be used in a conventional amount, such as, for example, 0.5 to 8 wt. % or more, or, from 2 to 6 wt. %, based on the total weight of the polyurethane foam except for the weight, in condensed form, of the (a) one or more aromatic polyisocyanates. Any surfactant used would comprise part of the polyol component of the foam forming compositions. Thus, the foam forming compositions may, for example, 0.5 to 8 wt. % or more, or, from 2 to 6 wt. %, of (d) one or more surfactants, based on the total weight of the polyol component.

The rigid polyurethane foams of the present invention may be fully water blown. Accordingly, the foam forming compositions may comprise (e) water as the blowing agent. However, the foams, may comprise one or more additional (e) blowing agents or blowing catalysts other than water. Thus, the polyol component may include water and a physical blowing agent such as hydrocarbons, hydrofluorocarbons, hydrochlorofluoroolefins, or hydrofluoroolefins. Blowing catalysts tend to favor the urea (blow) reaction.

Suitable (e) blowing agents suitable for use in the foam forming compositions may include any blowing catalyst or physical blowing agent known in the art or water. Blowing agent catalysts may be used in combination with one or more (g) gelling catalysts. As used herein, blowing agents may act as catalysts that favor the urea (blow) reaction. Suitable (e) blowing agents can include, for example, water, volatile organic materials, dissolved inert gases and combinations thereof. Examples of blowing agents include physical blowing agents which may be hydrocarbons such as butane, isobutane, 2,3-dimethylbutane, n- and i-pentane isomers, hexane isomers, heptane isomers and cycloalkanes including cyclopentane, cyclohexane, cycloheptane; hydroflurocarbons such as HCFC-142b (1-chloro-1,1-difluoroethane), HCFC-141b (1,1-dichloro-1-fluoroethane), HCFC-22 (chlorodifluoro-methane), HFC-245fa (1,1,1,3,3-pentafluoropropane), HFC-365mfc (1,1,1,3,3-penta-fluorobutane), HFC 227ea (1,1,1,2,3,3,3-heptafluoropropane), HFC-134a (1,1,1,2-tetrafluoroethane), HFC-125 (1,1,1,2,2-pentafluoroethane), HFC-143 (1,1,2-trifluoroethane), HFC 143A (1,1,1-trifluoroethane), HFC-152 (1,1-difluoroethane), HFC-227ea (1,1,1,2,3,3,3-heptafluoropropane), HFC-236ca(1,1,2,2,3,3-hexafluoropropane), HFC 236fa (1,1,1,3,3,3-hexafluoroethane), HFC 245ca (1,1,2,2,3-pentafluoropentane), HFC 356mff (1,1,1,4,4,4-hexafluorobutane), HFC 365mfc (1,1,1,3,3-pentafluorobutane); hydrofluoroolefins such as cis-1,1,1,4,4,4-hexafluoro-2-butene, 1,3,3,3-Tetrafluoropropene, trans-1-chloro-3,3,3-trifluoropropene or mixtures thereof. Suitable chemical blowing agents may include, for example, formic acid and water. The blowing agent can also include other volatile organic substances such as ethyl acetate; methanol; ethanol; halogen substituted alkanes, such as methylene chloride, chloroform, ethylidene chloride, vinylidene chloride, monofluorotrichloromethane, chlorodifluoromethane, dichlorodifluoromethane; butane; hexane; heptane; diethyl ether as well as gases such as nitrogen; air; and carbon dioxide. Examples of blowing catalysts, e.g., catalysts that may tend to favor the blowing reaction include, but are not limited to, short chain tertiary amines or tertiary amines containing an oxygen. The amine-based catalyst may not be sterically hindered. For instance, blowing catalysts include bis-(2-dimethylaminoethyl)ether; pentamethyldiethylene-triamine, triethylamine, tributyl amine, N,N-dimethylaminopropylamine, dimethylethanolamine, N,N,N′,N′-tetra-methylethylenediamine, and combinations thereof, among others. An example of a commercial blowing catalyst is POLYCAT™ 5, from Evonik.

Suitable total amounts of the (e) water in the foam forming compositions of the present invention range from 0.1 to 2.0 wt. %, preferably range from 0.3 to 1.2 wt %, based on the total weight of the polyol component. Suitable amounts of (e) one or more blowing agents other than water may range from 0 to 10 wt. %, such as 0.05 to 5 wt. %, preferably from 0.05 to 3 wt. %, based on the total weight of the polyol component. The (e) blowing a germ can be present in the polyol component in amount sufficient to provide the reaction mixture with, for example, from 0.1 to 5 wt. %, preferably 0.1 to 2 wt. % of the blowing agent based on the total weight of the polyol component.

Suitable as (f) halogen-free liquid flame-retardant additives may include, for example, a phosphate, a polyphosphate, a phosphonate, a phosphinate, a biphosphinate, and combinations thereof. Examples of the phosphate include trialkyl phosphate, triaryl phosphate, a phosphate ester and a resorcinol bis(diphenyl phosphate). As used herein, the term “trialkyl phosphate” refers to any phosphate that has three alkyl groups and at least one alkyl group with from 2 to 12 carbon atoms. The other two alkyl groups of the trialkyl phosphate may, independently, be the same or different than the first alkyl group, containing from one to 8 carbon atoms, including a linear or branched alkyl group, a cyclic alkyl group, an alkoxyethyl, a hydroxyalkyl, a hydroxyl alkoxyalkyl group, and a linear or branched alkylene group. Examples of the other two alkyl groups of the trialkyl phosphate include, for example, methyl, ethyl, propyl, butyl, n-propyl, isopropyl. n-butyl, isobutyl, sec-butyl, tert-butyl, butoxyethyl, isopentyl, neopentyl, isohexyl, isoheptyl, cyclohexyl, propylene, 2-methylpropylene, neopentylene, hydroxymethyl, hydroxyethyl, hydroxypropyl or hydroxybutyl. The three alkyl groups of the trialkyl phosphate may be the same. Blends of two or more trialkyl phosphates may also be used. Examples of the phosphonate may include, for example, diethyl (hydroxymethyl)phosphonate, dimethyl methyl phosphonate and diethyl ethyl phosphonate. Examples of the phosphinates may include, for example, a metal salt of organic phosphinate such as aluminum methylethylphosphinate, aluminum diethylphosphinate, zinc methylethylphosphinate, and zinc diethylphosphinate. Metal containing additives are less preferred. Preferably, the halogen-free flame-retardant additive is an organic phosphate, such as a trialkyl phosphate, for example, triethyl phosphate (TEP). The rigid polyurethane foams of the present invention comprise, dispersed within the polyurethane foam, (f) from 2 to less than 15 wt. % or, preferably, from 5 to 10 wt. %, based on the total weight of the polyurethane foam except for the weight, in condensed form, of the (a) one or more aromatic polyisocyanates, of a chlorine-free liquid flame retardant additive, such as a liquid phosphate flame retardant additive, for example a trialkyl phosphate, or a blend of the liquid phosphate with a reactive bromine-containing liquid. Thus, the rigid polyurethane foams of the present invention may include an additional, reactive liquid bromine containing flame retardant additive, for example, having a hydroxyl functionality of at least 1. The bromine content of the rigid polyurethane foams may preferably be less than 1.8 wt. %, based on the total weight of the polyurethane foam except for the weight, in condensed form, of the (a) one or more aromatic polyisocyanates, or, preferably, 0 wt. %.

Preferably, the rigid polyurethane foams consist essentially of one halogen free liquid flame retardant (FR) additive, such as, for example, a phosphate or a trialkyl phosphate.

The same FR additives in the foams generally comprise part of the polyol component of the foam forming compositions. Accordingly, the foam forming compositions comprise (f) bromine containing (f) from 3 to less than 15 wt. % or, preferably, from 5 to 10 wt. %, based on the total weight of the polyol component, of a chlorine-free liquid flame retardant additive, such as a liquid phosphate flame retardant additive, for example a trialkyl phosphate, or a blend of of the liquid phosphate with a bromine-containing liquid. The polyol component may include an additional reactive liquid bromine containing flame retardant additive with hydroxy functionality of at least 1, The bromine content of the rigid polyurethane foams may preferably be less than 1.8 wt. %, based on the total weight of the polyol component, or, preferably, 0 wt. %. The polyol component of the foam forming compositions of the present invention further comprise (g) one or more gelling catalyst. As used herein, gelling catalysts favor the urethane (gel) reaction.

Examples of suitable (g) gelling catalysts may include tertiary amines, such as, for example, trimethylamine, triethylamine, N-methylmorpholine, N-ethylmorpholine, N-coco-morpholine, morpholine, N,N-dimethylcyclohexylamine, pentamethyldiethylenetriamine, tetramethyl ethylenediamine, bis(dimethylaminoethyl)ether, 3-methoxy-N-dimethylpropylamine, dimethylethanolamine, N,N-dimethyl-N′,N′-dimethyl isopropylpropylenediamine, N,N-diethyl-3-diethylamino-propylamine, N,N-dimethylbenzylamine, N,N-dimethylethanolamine, N,N-dimethylpiperazine, 1-methyl-4-dimethylaminoethyl-piperazine, 1,4-diazobicyclo[2,2,2]octane, bis(dimethylaminoethyl)ether, bis(2-dimethylaminoethyl)ether, N,N-dimorpholine diethylether, 4,4′-(oxydi-2,1-ethanediyl) bis, pentamethylene diamine, and mixtures thereof. Preferably, the (g) one or more gelling catalysts comprise an aromatic amine tertiary amine catalyst, such as, for example, benzyldimethylamine. Examples of commercially available gelling catalysts include POLYCAT™ 8 and DABCO™ T-12 catalysts from Evonik.

The (g) gelling catalysts may be used in a conventional amount, such as, for example, 0.1 to 3 wt. %, or, from 0.1 to 1 wt. %, or, from 0.2 to 1.0 wt. %, based on the total weight of the polyurethane foam except for the weight, in condensed form, of the (a) one or more aromatic polyisocyanates. Any catalyst used would comprise part of the polyol component of the foam forming compositions. Thus, the foam forming compositions may comprise, for example, 0.1 to 3 wt. %, or, from 0.1 to 1 wt. %, or, from 0.2 to 1 wt. %, in total of (g) gelling catalysts, based on the total weight of the polyol component.

The rigid polyurethane foams of the present invention may comprise, in condensed form, (h)(i) a reactive diluent, such as, for example, bis(3-chloro-4-aminophenyl)methane or 2,4-diamino-3,5-diethyl toluene. Such diluents may lower the viscosity of foam forming compositions containing them and then react in to the rigid polyurethane foam. Other suitable diluents may also be a non-reactive compatible liquids, such as propylene carbonate that serves to lower the viscosity of the foam forming compositions containing them. The (h)(i) reactive diluents and the may be used in a conventional amount, such as, for example, 0 to 8 wt. %, based on the total weight of the polyurethane foam except for the weight, in condensed form, of the (a) one or more aromatic polyisocyanates. Any reactive diluent or diluent solvent used would comprise part of the polyol component of the foam forming compositions. Thus, the foam forming compositions may comprise, for example, 0 to 8 wt. % of one or more (h)(i) reactive diluents, based on the total weight of the polyol component. Total amounts of the (h)(iii) diluent solvent may range from 0 to 10 wt. %, based on the total weight of the polyol component.

The rigid polyurethane foams of the present invention may comprise in condensed form, (h)(ii) a crosslinker, such as a trifunctional crosslinker, for example, tri(isopropanol) amine or triethanolamine. Examples of suitable crosslinkers may include diethanol amine, triethanol amine, di- or tri-(isopropanol) amine, glycerine, trimethylol propane, pentaerythritol, and sorbitol. The total amount of the (h)(ii) crosslinkers may range from 0 to 10 wt. %, for example, up to 8 wt. %, based on the total weight of the polyurethane foam except for the weight, in condensed form, of the (a) one or more aromatic polyisocyanates, for example, 0.1 wt. % or more, or, 0.5 wt. % or more, and at the same time 3 wt. % or less. Any crosslinker used would comprise part of the polyol component of the foam forming compositions. Thus, the foam forming compositions may comprise, for example, 0 to 8 wt. % of one or more (h)(2) crosslinkers, based on the total weight of the polyol component, for example, 0.1 wt. % or more, or, 0.5 wt. % or more, and at the same time 3 wt. % or less.

The rigid polyurethane foams of the present invention meet and exceed the requirements of the ASTM E84 Class I (Class A) as a foam having a 2.54 cm (1 in) thickness and exhibit a smoke developed index (SDI) of 450 or less or, preferably, 250 or less, and a flame spread index (FSI) of 25 or less.

In accordance with another aspect of the present invention, methods of making a flame retardant rigid polyurethane foam comprise any method for forming a rigid foam from a two-component foam forming composition. The methods may comprise, for example:
combining the polyisocyanate component of the two-component foam forming composition with the polyol component thereof in a high-pressure foaming machine; and,
further, may comprise pouring the resulting foam forming composition into a closed mold.

Molding using a closed molding or molding under pressure facilitates formation of higher density foams.

The rigid polyurethane foams of the present invention may find use in decorative, construction or landscaping applications, such as in insulation, in imitation wood or stone or any application where a high density product with fire performance is required.

### Examples

The following examples illustrate the present invention. Unless otherwise indicated, all temperatures are ambient or room temperature (21-25° C.), all pressures are 1 atmosphere and relative humidity (RH) is 50%. Notwithstanding that the numerical ranges and parameters setting forth the broad scope of the invention are approximations; and numerical values set forth in the specific examples are reported as precisely as possible. Any numerical value inherently contains certain errors necessarily resulting from the standard variation found in their respective testing measurements.

The materials used in the Examples and not otherwise defined, below, are set forth in Tables 1A, 1B and 1C, below. Abbreviations used in the examples include: CE: Comparative Example; DEOA: Diethanolamine; EO: Ethylene oxide; FR: Flame Retardant Additive; HEW: Hydroxyl equivalent weight; MDI: methylene di (phenyl isocyanate); NCO: Isocyanate; OH: hydroxyl; OHn: Hydroxyl Number; PO: propylene oxide; TEP: Triethyl phosphate.

The following materials were used in the following examples:

Low hydroxyl functional aromatic polyester polyol 1: A polyester polyol from terephthalic acid, diethylene glycol, polyethylene glycol, and glycerine; functionality: 2.0; OH number: 220 (Dow). Viscosity 2,000 cp at 25° C.; OH equivalent weight: 255;

Low hydroxyl functional aromatic polyester polyol 2; A polyester polyol from terephthalic acid, diethylene glycol, polyethylene glycol, and glycerine; functionality: 2.4; OH number: 315 (Dow). Viscosity 5,000 cp at 25° C.; OH equivalent weight: 178;

High hydroxyl functional aromatic polyester polyol: A polyester polyol from terephthalic acid, diethylene glycol, polyethylene glycol and glycerine; functionality: 2.7; OH number: 270 (Dow).

Viscosity 14,000 cp @ 25° C.; OH equivalent weight: 204;

Novolac polyether polyol: An aromatic resin-initiated oxypropylene-oxyethylene polyol with hydroxyl number of 195 mg KOH/g and average functionality of 3.3;

Diluent 1: Propylene Carbonate, a JEFFSOL PC solvent viscosity reducer (Huntsman Chemicals, Inc., Salt Lake City, UT);

Diluent 2: poly(propylene glycol) with a molecular weight of ˜400;

Bromine containing FR Additive 1: RB44SG reactive, bromine containing flame retardant mixture, with 53 wt. % bromine with a hydroxyl number ranging from of 160 to 185 mg KOH/g (St. Louis Group, Indianapolis, IN);

Bromine containing FR Additive 2: SAYTEX RB-79 reactive bromine-containing diester/ether diol of tetrabromophthalic anhydride, with 45 wt. % bromine (Albemarle Corporation, Cary, NC);

Bromine and chlorine containing FR Additive 3: IXOL B251 bromine containing aliphatic polyether triol; OH number=330, with 31.5 wt. % bromine (Solvay Chemicals, Brussels, BE); Chlorinated FR Additive: TCPP is a tris-(chloroisopropyl) phosphate flame retardant (ICL-Americas, St Louis, MO);

Liquid FR Additive: TEP is a triethylphosphate, flame retardant (Eastman Chemical Company, Kingsport, TN);

Fl Blowing agent 1: HFC-245fa, 1,1,1,3,3-pentafluoropropane blowing agent (Honeywell, Morris Plains, NJ);

Fl Blowing agent 2: SOLSTICE LBA trans-1-chloro-3,3,3-trifluoropropene blowing agent (Honeywell, Morris Plains, NJ);

Catalyst 1: POLYCAT 8 N,N-dimethylcyclohexylamine containing catalyst (Evonik);

Catalyst 2: DABCO 1028 non-acid blocked, delayed-action catalyst solution of triethylene diamine in 1,4-butylene glycol (Evonik);

Catalyst 3: Benzyldimethylamine (BDMA) is an aromatic catalyst (Evonik):

Trimerization catalyst 1: TMR-2 2-hydroxypropyl trimethylammonium formate in a dipropylene glycol carrier (Evonik);

Trimerization catalyst 2: DABCO™ TMR-3 A quaternary amine trimerization catalyst (Evonik);

Trimerization catalyst 3: DABCO™ TMR-18 quaternary amine trimerization catalyst product in a hydroxyl carrier (Evonik);

Trimerization catalyst 4: DABCO K2097 catalyst solution of potassium-acetate in a diethylene glycol carrier (Evonik);

Silicon containing surfactant: VORASURF™ DC 193 general-purpose siloxane surfactant for rigid polyurethane foam applications (Dow);

Polymeric MDI: PAPI™ 27 polymethylene polyphenylisocyanate containing methylene diphenyl diisocyanate (MDI) with 31.4 wt. % NCO, 2.7 NCO groups (Dow).

Molding to form Foam Boards: The indicated amounts of polyol component as shown in Table 1, below, were weighed and added into a 45-Liter (12-gallon) plastic bucket, followed by a thorough mixing for 30 minutes (until homogeneous) with an air or electric mixer. The resulting polyol component was then loaded into the polyol tank of a high pressure foam forming machine, such as a Serie 2 from OMS, (ECOMASTER 2 60/30 model, Impianti OMS SpA, Verano Brianza, IT). The indicated polyisocyanate was loaded into the iso tank of the same high pressure machine. The indicated components of the two-component foam formulation were mixed together by high-pressure impingement mixing and immediately introduced into a mold cavity where the formulation was allowed to react and expand. The pump pressure of both the isocyanate and polyol streams in the machine were at 135 to 180 bar and the temperature of both the polyol and isocyanate streams were set at 20 to 40° C., raising it as needed to lower viscosity. The mold cavity comprised a flat plate mold having dimensions of 100 cm (Length)×53 cm (Width)×2.54 cm (Thickness or Height). The “Thickness or Height” direction of the mold corresponds to the foam rise direction during the foam preparation. The flat plate mold was pre-heated to 45 to 50° C. in an oven. The form foaming composition was injected into the mold and cured in the mold for 20 min before removing the foam from the mold. All foams were placed on a lab bench for at least 24 hours prior to conducting physical property testing. The density of the resulting of the molded plates (boards) was 200 kg/m³.

Test Methods: The Following Test Methods were Used in the Examples:

ASTM E84: ASTM E84-18b “Standard Method of Test for Surface Burning Characteristics of Building Materials” (Publication date 2019) CLASS A. In the test, two foam boards produced using the same formulation in the mold according to the molding method, above, were adhered end to end widthwise to produce a long board with dimensions of 200 cm (Length)×53 cm (Width)×2.54 cm for testing. In the test, the smaller the value, the better the fire performance. FSI—flame spread index of 25 or less; SDI—smoke developed index SDI of 450 or lessor, preferably, 250 or less. A mechanical support, such as a chicken wire mesh, may be placed under the board to maintain its the integrity during testing and address sagging boards. When that is done the test is considered so modified.

Density (of foam board): Determined in accordance with ASTM D 1622.

Viscosity at 25° C. (of formulation or of polyol component): Viscosity was determined in accordance with ASTM D4878 using a viscometer model Brookfield DV-I Prime equipped with a rotating spindle using a speed of 60 rpm to measure Dynamic Viscosity.

TABLE 1
Formulations

| | | | | | | | | | | |
|---|---|---|---|---|---|---|---|---|---|---|
| Example | CEx1* | CEx2* | CEx3* | CEx4* | CEx5* | CEx6* | 1 | 2 | 3 | 4 |

Polyol Component

| | | | | | | | | | | |
|---|---|---|---|---|---|---|---|---|---|---|
| Low hydroxyl functional | | | | | | | | | | 40.13 |
| aromatic polyester polyol 1 | | | | | | | | | | |
| Low hydroxyl functional | | | | | | 42.11 | 42.50 | 25.30 | 32.97 | |
| aromatic polyester polyol 2 | | | | | | | | | | |
| High hydroxyl functional | 66.90 | 56.00 | 59.55 | 60.98 | 55.35 | 27.02 | 28.00 | 49.52 | 25.98 | 25.14 |
| aromatic polyester polyol 1 | | | | | | | | | | |
| Novolac Polyether polyol | 13.00 | 15.00 | 13.00 | 13.01 | 13.00 | 13.01 | 13.00 | 13.00 | 12.99 | 12.27 |
| Diluent 1 | | | | 4.50 | 4.50 | | | | 5.00 | |
| Diluent 2 | | | | | | | | | 3.00 | |
| Tri(isopropanol) amine crosslinker | | | | | | | | | | 5.67 |
| Bromine containing FR additive 1 | 10.00 | 15.00 | 10.00 | | | 8.02 | | | | |
| Bromine containing FR additive 2 | | | | 8.01 | | | 7.00 | | 7.99 | 7.55 |
| Bromine containing FR additive 3 | | | | | 13.64 | | | | | |
| Chlorinated FR additive | 2.00 | 6.00 | 2.00 | | | | | | | |
| FR additive (TEP) | 2.00 | | 2.00 | 4.00 | 4.00 | 4.01 | 3.50 | 6.00 | 5.99 | 3.78 |
| Fl Blowing agent 1 | | 4.00 | | | | | | | | |
| Fl Blowing agent 2 | | | 8.00 | 4.00 | 4.00 | | | | | |
| Catalyst 1 | 0.10 | | 0.10 | 0.02 | 0.02 | 0.02 | 0.08 | 0.08 | 0.06 | |
| Catalyst 2 | | 0.30 | | | | | | | | |
| Catalyst 3 | 0.50 | 0.30 | 0.50 | 0.44 | 0.44 | 0.44 | 0.25 | 0.25 | 0.25 | |
| Trimerization catalyst 1 | | 0.60 | | 0.20 | 0.20 | 0.20 | 0.30 | 0.30 | | |
| Trimerization catalyst 2 | | | | | | | | | 0.43 | |
| Trimerization catalyst 3 | 0.40 | | 0.40 | 0.18 | | 0.18 | 0.27 | 0.45 | 0.25 | 0.57 |
| Trimerization catalyst 4 | 0.10 | 0.20 | 0.10 | | 0.18 | | | | | 0.08 |
| Silicon containing surfactant | 4.00 | 2.00 | 4.00 | 4.01 | 4.00 | 4.01 | 4.00 | 4.00 | 4.00 | 3.78 |
| Blowing agent 3 (water) | 1.00 | 0.60 | 0.35 | 0.65 | 0.65 | 1.00 | 1.10 | 1.10 | 1.10 | 1.04 |
| Total | 100 | 100 | 100 | 100 | 100 | 100 | 100 | 100 | 100 | 100 |

Polyisocyanate (A)

| | | | | | | | | | | |
|---|---|---|---|---|---|---|---|---|---|---|
| Polymeric MDI | 116 | 116 | 110 | 100 | 107 | 125 | 127 | 152 | 118 | 124 |

*—Denotes Comparative Example.

TABLE 2
Foam and Formulation Properties and Test Results

| Example | CEx1* | CEx2* | CEx3* | CEx4* | CEx5* | CEx6* | 1 | 2 | 3 | 4 |
|---|---|---|---|---|---|---|---|---|---|---|
| [[ref ID | 1734.42 | 1734.39 | 1734.41 | 1734.417 | 1734.419 | 1734.418 | 1734.50 | 1734.51 | 1734.54.4 | 1734.55.08]] |

Formulation Features

| | | | | | | | | | | |
|---|---|---|---|---|---|---|---|---|---|---|
| NCO Index | 164 | 190 | 197 | 162 | 166 | 165 | 162.0 | 200.0 | 162.0 | 162.0 |
| Polyol Component | 6820 | 5170 | 2687 | 2300 | 1789 | 2730 | 2900 | 3154 | 1450 | 1800.0 |
| Viscosity@25 C. | | | | | | | | | | |
| (cPs) | | | | | | | | | | |
| Chlorinated FR | 0.93% | 2.78% | 0.95% | 0.00% | 0.00% | 0.00% | 0.00% | 0.00% | 0.00% | 0.00% |
| additive (wt. %) | | | | | | | | | | |
| Br wt. % (based | 2.45% | 3.68% | 2.52% | 1.84% | 2.08% | 1.89% | 1.42% | 0.00% | 1.69% | 1.55% |
| on total polyol | | | | | | | | | | |
| component) | | | | | | | | | | |
| Foam Properties | | | | | | | | | | |
| Board Density | 200 | 200 | 200 | 200 | 200 | 200 | 200 | 200 | 200 | 200 |
| (kg/m³) | | | | | | | | | | |
| ASTM E84 | | | | | | | | | | |
| Board | 2.54 | 2.54 | 2.54 | 2.54 | 2.54 | 2.54 | 2.54 | 2.54 | 2.54 | 2.54 |
| thickness (cm) | | | | | | | | | | |
| Flame Spread Index | 20 | 20 | 25 | 20 | 20 | 20 | 25 | 25 | 20 | 25 |
| Smoke | 170 | 250 | 300 | 350 | 500 | 350 | 250 | 200 | 200 | 250 |
| Developed Index | | | | | | | | | | |

*—Denotes Comparative Example.

As shown in Table 2, above, including a low hydroxyl functional polyester polyol in place of at least a portion of a high hydroxyl functional aromatic polyester polyol, as in Examples 1, 2, and 4 dramatically reduced the viscosity of the polyol component as compared to Comparative Examples 1, and 2; the viscosity of the polyol component in Comparative Example 3 was lowered by the use of Blowing agent 2. In the foam forming compositions of Examples 1, 2, 3 and 4, replacing the non-reactive halogen containing phosphate FR additive of Comparative Example 2 with a halogen-free phosphate (TEP) and reducing the bromine containing FR additive content, enabled lower total halogen content and even a halogen free composition that provided a high-density rigid polyurethane foam that exhibited reduced smoke developed index (SDI) while maintaining a desirable flame spread index (FSI). Further, as shown in Example 3, as compared to Comparative Example 4 and 5 where a diluent was present, a poor SDI resulted without the presence of a low hydroxyl functional aromatic polyester polyol. Still further, the use of a fluorine containing Blowing agent in Comparative Examples 3, 4, and 5, led to increase of smoke generation and a higher SDI, for example, of 300 or more. Meanwhile, use of diluent to lower viscosity to less than 3,500 cPs and replacing a chlorinated non-reactive FR additive with TEP led to a significant increase of smoke generation in Comp Examples 4 and 5. In contrast, the inventive foam forming compositions of Example 3 enabled a significant reduction in smoke generation in a composition containing a chlorine free FR additive while including diluents to ease formulation. Still further, although Comparative Example 6 uses a low hydroxyl functionality polyester polyol to lower viscosity to less than 3,500 cPs, the foam from the composition exhibited a poor SDI from a high bromine containing FR additive content having a bromine content higher than 1.8 wt. %, based on the total weight of foam forming composition. In contrast, the inventive foam forming compositions of Example 1 and 2 enabled significant reduction in SDI with a bromine content less than 1.8 wt % based on the total weight of foam forming composition. Thus, the fully liquid foam forming compositions of Examples 1, 2, 3 and 4 enabled replacement of a halogen containing FR additive with a halogen free FR additive (TEP), such as in Example 2, and eliminated chlorine from the FR additive while reducing or eliminating bromine content and lowering viscosity (<3,500 cp). At the same time, the inventive compositions offered significantly reduced smoke generation (SDI) while maintaining the required flame spread (FSI) performance.

We claim:

1. A two-component, all liquid foam forming composition for making a fire-resistant high-density rigid polyurethane foam comprises:
a polyisocyanate component of:
(a) one or more aromatic polyisocyanates having from 2 to 5 isocyanate groups; and,
as a separate component,
a polyol component of:
(b)(i) from 47 to 86.75 wt. %, based on the total weight of the polyol component, of a blend of from 20 to 80 weight parts of the total weight of (b)(i) of (A) one or more high hydroxyl functional aromatic polyester polyols having an average hydroxyl functionality of from 2.5 to 4, and having a hydroxyl number as determined in accordance with ASTM D4274 of from 200 to 350 mg KOH/g, and from 20 to 80 weight parts of the total weight of (b)(i) of (B) one or more low hydroxyl functional aromatic polyester polyols having a hydroxyl functionality of from 1.8 to less than 2.5, having a viscosity at 25° C., as determined in accordance with ASTM D4878 using a viscometer equipped with a rotating spindle of from 1000 to less than 7000 cPs, and, having a hydroxyl number as determined in accordance with ASTM D4274 of from 180 to 350 mg KOH/g, wherein the difference in the average hydroxyl functionality of the (b)(i)(A) one or more hydroxyl functional aromatic polyester polyols and the (b)(i)(B) low hydroxyl functional aromatic polyester polyols is 0.2 or more hydroxy groups;
(b)(ii) from 8 to 20 wt. %, based on the total weight of the polyol component, of one or more novolac polyether polyols having a hydroxyl functionality of from 2 to 6, and having an hydroxyl number as determined in accordance with ASTM D4274 of from 150 to 320;
(c) from 0.2 to 2 wt. %, based on the total weight of the polyol component, of one or more trimerization catalysts;
(d) from 2 to 6 wt. %, based on the total weight of the polyol component, of a nonionic surfactant;
(e) from 0.05 to 10 wt. %, based on the total weight of the polyol component, of water, a liquid physical blowing agent, a blowing catalyst, or a mixture of two or more thereof as a blowing agent, wherein the water comprises no more than 2 wt. %, based on the total weight of the polyol component; and,
(f) from 3 to less than 15 wt. %, based on the total weight of the polyol component, of a flame retardant (FR) additive comprising a liquid chlorine-free phosphate flame retardant additive or a mixture of the liquid phosphate and a reactive bromine containing flame retardant additive,
wherein the two-component foam forming composition has an isocyanate index ranging from 120 to 240 and all wt. % s add up to 100%.

2. The two-component, all liquid foam forming composition for making a fire-resistant high-density rigid polyurethane foam as claimed in claim 1, wherein, in the polyol component, the difference in the average hydroxyl functionality of the (b)(i)(A) one or more hydroxyl functional aromatic polyester polyols and the (b)(i)(B) one or more low hydroxyl functional aromatic polyester polyols is 0.25 or more hydroxyl groups.

3. The two-component, all liquid foam forming composition for making a fire-resistant high-density rigid polyurethane foam as claimed in claim 1, wherein the (b)(i)(A) one or more high hydroxyl functional aromatic polyester polyols has a viscosity at 25° C., as determined in accordance with ASTM D4878 using a viscometer equipped with a rotating spindle of from from 5000 to 25000 cPs.

4. The two-component, all liquid foam forming composition for making a fire-resistant high-density rigid polyurethane foam as claimed in claim 1, wherein the (d) nonionic surfactant is a silicon containing surfactant or a nonionic surfactant.

5. The two-component, all liquid foam forming composition for making a fire-resistant rigid polyurethane foam as claimed in claim 1, wherein the (e) blowing agent comprises water.

6. The two-component, all liquid foam forming composition for making a fire-resistant rigid polyurethane foam as claimed in claim 1, wherein the (f) flame retardant additive comprises a trialkyl phosphate having three alkyl groups with at least one alkyl group having from 2 to 12 carbon atoms and the other two alkyl groups, independently, containing from one to 8 carbon atoms.

7. The two-component, all liquid foam forming composition for making a fire-resistant rigid polyurethane foam as claimed in claim 6, wherein the (f) flame retardant additive comprises triethyl phosphate.

8. The two-component, all liquid foam forming composition for making a fire-resistant rigid polyurethane foam as claimed in claim 6, wherein the (f) flame retardant additive is a mixture of the trialkyl phosphate and a reactive bromine containing flame retardant additive.

9. The two-component, all liquid foam forming composition for making a fire-resistant rigid polyurethane foam as claimed in claim 6, wherein the foam forming composition consists essentially of (f) one halogen-free flame liquid phosphate retardant additive.

10. A rigid polyurethane foam comprising:
(a) in condensed form, one or more aromatic polyisocyanates having from 2 to 5 isocyanate groups, and containing at least one isocyanurate ring; and
(b)(i) in condensed form, from 57 to 86.8 wt. %, based on the total weight of the polyurethane foam except for the weight, in condensed form, of the (a) one or more aromatic polyisocyanates, of a blend of from 20 to 80 weight parts of the total weight, in condensed form, of (b)(i) of (A) one or more high hydroxyl functional aromatic polyester polyols having a hydroxyl functionality of from 2.5 to 4, and having an hydroxyl number as determined in accordance with ASTM D4274 of from 200 to 350 mg KOH/g, and from 20 to 80 weight parts of the total weight, in condensed form, of (b)(i) of (B) one or more low hydroxyl functional aromatic polyester polyols having a hydroxyl functionality of from 1.8 to less than 2.5, and, having an hydroxyl number as determined in accordance with ASTM D4274 of from 180 to 350 mg KOH/g, wherein the difference in the average hydroxyl functionality of the (b)(i)(A) one or more hydroxyl functional aromatic polyester polyols and the (b)(i)(B) low hydroxyl functional aromatic polyester polyols is 0.2 or more hydroxy groups;
(b)(ii) in condensed form, from 8 to 20 wt. %, based on the total weight of the polyurethane foam except for the weight, in condensed form, of the (a) one or more aromatic polyisocyanates, of one or more novolac polyether polyols having a hydroxyl functionality of from 2 to 6, and a hydroxyl number as determined in accordance with ASTM D4274 of from 150 to 320;
(c) dispersed within the polyurethane foam from 0.2 to 2.0 wt. %, based on the total weight of the polyurethane foam except for the weight, in condensed form, of the (a) one or more aromatic polyisocyanates, of one or more trimerization catalysts;
(d) dispersed within the polyurethane foam from 2 to 6 wt. %, based on the total weight of the polyurethane foam except for the weight, in condensed form, of the (a) one or more aromatic polyisocyanates, of a nonionic surfactant; and,
(f) dispersed within the polyurethane foam from 3 to less than 15 wt. %, based on the total weight of the polyurethane foam except for the weight, in condensed form, of the (a) one or more aromatic polyisocyanates, of a (f) flame retardant additive comprising a chlorine-free liquid phosphate,
wherein the rigid polyurethane foam foam comprises at least one isocyanurate group, has a density as determined in accordance with ASTM D 1622 of from 160 to 480 kg/m³ (10 to 30 pounds per cubic foot), and all wt. % s add up to 100%; and,
still further wherein, the rigid polyurethane foam meets the requirements of the ASTM E84 Class I (Class A) as a foam having a 2.54 cm (1 in) thickness and exhibits a smoke developed index (SDI) of 450 or less and a flame spread index (FSI) of 25 or less.
